(19) United States
(12) Patent Application Publication
(10) Pub. No.: US 2003/0167193 A1
(43) Pub. Date: Sep. 4, 2003

(54) Attendance monitoring system

(76) Inventors: Wallace R. Jones, Concord Twp., OH (US); Jennifer L. Rickenbacker, Wadsworth, OH (US)

Correspondence Address: Joseph D. Dreher, Esq., Fay, Sharpe, Fagan, Minnich & McKee, LLP, 7th Floor, 1100 Superior Avenue, Cleveland, OH, 44114-2518, US

(21) Appl. No.: 10/337,742

(22) Filed: Jan. 7, 2003

Related U.S. Application Data
(60) Provisional application No. 60/346,645, filed on Jan. 8, 2002.

(51) Int. Cl. G06F 17/60

(52) U.S. Cl. 705/7

(57) ABSTRACT

This invention relates to an attendance monitoring system. More particularly, the invention is directed to a system that provides to an employer an instant visual representation of an employee's daily attendance (including that for the present day), attendance history (which is an indicator of reliability), available paid time off, current vacation schedule, assignment status, training status, and the like.

This application claims the benefit of U.S. Provisional Application Ser. No. 60/346,490, filed on Jan. 8, 2002, the disclosure of which is incorporated herein by reference.

### BACKGROUND OF THE INVENTION

This invention relates to an attendance monitoring system. More particularly, the invention is directed to a system that provides to an employer an instant visual representation of an employee's daily attendance (including that for the present day), attendance history (which is an indicator of reliability), available paid time off, current vacation schedule, assignment status, training status, and the like.

While the invention is particularly directed to the art of attendance monitoring in a paid labor environment, and will be thus described with specific reference thereto, it will be appreciated that the invention may have usefulness in other fields and applications. For example, the invention may be implemented in any environment where attendance and reliability of individuals is important to the success of a particular endeavor.

By way of background, in many organizations, no reliable method for monitoring employee attendance is available. This, of course, impacts on efficiency and production.

ADP, Inc. offers an automated time keeping system (i.e., eTime) that collects employee time information. eTime includes electronic terminals for clocking in and out. Various types of electronic terminals are available, including time clocks with card readers and/or keypads, hand punches using biometrics, and computer stations with a display monitor and keyboard or pointing device. The electronic terminals run eTime client software and communicate the employee information to a centralized computer station. The central computer applies an employer's time keeping policies to the employee information and calculates various totals. Various reports can be generated as needed for review of the employee information. The employee time information can be communicated to payroll where it can be used to generate paychecks through a payroll service.

ADP, Inc. also offers an automated payroll software package (i.e., PC Payroll) that provides a wide range of payroll services. For example, PC Payroll processes employee time information, applies standard and elected deductions, prints employee paychecks, compiles management reports, and prepares tax filings. PC Payroll is compatible with various computer systems, including standalone computers, networked workstations, and networked servers. Permanent employee payroll information can be added, changed, and deleted using PC Payroll, including pay rate, status, deduction limits, benefit plans, direct deposits, garnishments, Additionally, PC Payroll is compatible with employee time information from eTime.

Even where attendance is monitored in some manner, many of the techniques to do so, which are well known to those familiar with payroll and human resource areas of industry, are not as efficient and reliable as desired. Such techniques typically require an excessive amount of manual data input, as well as the input of duplicative data to different areas of a payroll and/or attendance system. For example, an organization may have a system for payroll, a system for attendance and a manual system, such as a spreadsheet, for monitoring attendance and attendance history. However, data input to these systems may be duplicative and could even be inconsistent.

As a result, companies require extra personnel to be available to account for times when regular staff is unexpectedly not available. This alone can increase payroll unnecessarily. Moreover, even where the extra staff is available, it is nonetheless difficult to match the production of regular staff. As a result, organizations are often required to expedite freight costs, or take other expensive measures, to compensate for lost time in the manufacturing process.

As such, it would be desirable to have a convenient system that provides a daily awareness of attendance status and of the reliability of the staff that is available. Such a system would reduce the need for regular staff, eliminate the need for extra staff, significantly reduce overtime, and, of course, reduce costs such as expedited freight costs. It would also provide employers with an efficient tool for planning purposes.

The present invention contemplates a new and improved system for monitoring attendance that resolves the above-referenced difficulties and others.

### SUMMARY OF THE INVENTION

An attendance monitoring system is provided. This system provides to an employer an instant visual representation of an employee's daily attendance (including that for the present day), attendance history (which is an indicator of reliability), available paid time off, current vacation schedule, assignment status, training status, and the like.

Advantages of the system are that it provides a daily awareness of attendance status and of the reliability of the staff that is available. In addition, it reduces the need for regular staff, eliminates the need for extra staff, significantly reduces overtime, and of course, reduces costs such as expedited freight costs. Moreover, it also provides employers with an efficient tool for planning purposes.

Further, the system allows for instant employee reassignment capabilities for reducing the total number of employees required, particularly extra staff. This is more efficient, will allow for more training time and allow for extra jobs to be completed if extra staff is available.

Further scope of the applicability of the present invention will become apparent from the detailed description provided below. It should be understood, however, that the detailed description and specific examples, while indicating preferred embodiments of the invention, are given by way of illustration only, since various changes and modifications within the spirit and scope of the invention will become apparent to those skilled in the art.

### DESCRIPTION OF THE DRAWINGS

The present invention exists in the construction, arrangement, and combination of the various parts and functions of the system whereby the objects contemplated are attained as hereinafter more fully set forth and illustrated in the accompanying drawings in which:

FIG. 1 is an illustration of an attendance monitoring system according to the present invention.

FIG. 2 is an illustration of an implementation according to the present invention.

FIG. 3 is an illustration of an implementation according to the present invention.

FIG. 4 is an illustration of an implementation according to the present invention.

### DETAILED DESCRIPTION OF THE PREFERRED EMBODIMENTS

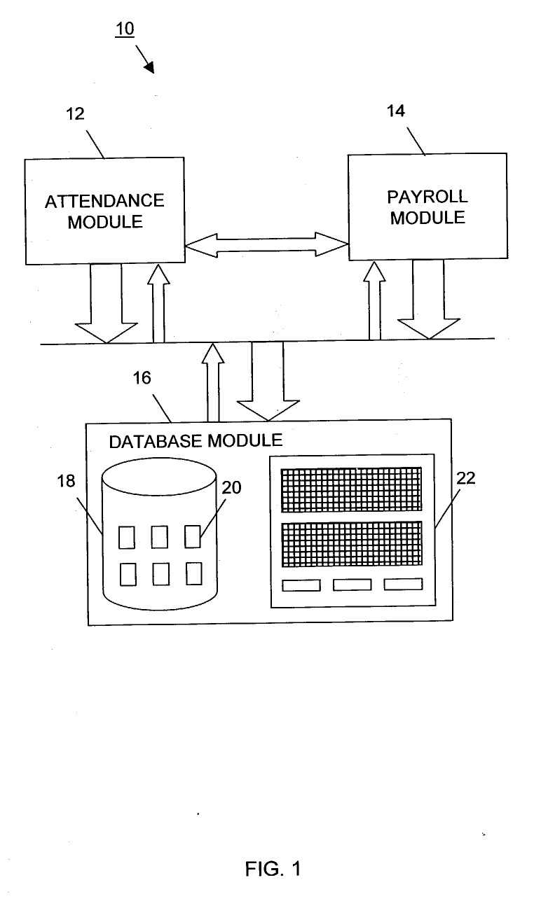

Referring now to the drawings wherein the showings are for purposes of illustrating the preferred embodiments of the invention only and not for purposes of limiting same, FIG. 1 provides a view of an overall preferred system according to the present invention. As shown, an attendance monitoring system 10 includes an attendance module 12, a payroll module 14 and a database module 16.

The attendance module 12 is preferably an “e-Time” module (provided by ADP, Inc.) and has a variety of functions that will be apparent to those individuals familiar with the payroll processing industry. For example, the module 12 processes attendance data in connection with employees that “punch in” when beginning a shift of work and “punch out” when the shift, or a portion thereof, is completed. The data typically processed is the employee name, employee department (or assignment), time of the “punch in” and time of any “punch out.” Techniques for inputting data to such a module are well known (e.g. time cards, hand scan, . . . etc.). It should be appreciated that, although a preferred module 12 is identified, any suitable attendance (or time clock) device may be used provided that it generates or maintains the above requisite data, the use of which will be discussed in greater detail hereafter.

The payroll module 14 is preferably a “PC Payroll” module (provided by ADP, Inc.) and has a variety of functions that will be apparent to those individuals in the payroll processing industry. For example, the module 14 maintains information on the identification of employees, locations (or assignments) of employees, employee numbers (or clock numbers), hire dates for employees, available time off for employees, and historical information on employee attendance. Techniques for inputting data to such a module are well known (e.g. manual or automated input). It should be appreciated that, although a preferred module 14 is identified, any suitable payroll system may be used provided that it generates or maintains the above requisite data, the use of which will be discussed in greater detail hereafter.

The database module 16 is preferably comprised of an access or relational database 18 including a variety of tables 20 and a plurality of forms or templates 22 that provide a suitable user interface. It will be appreciated that the forms or templates 22 accept and use data stored in the tables 20. This provides a convenient manner in which users may view and navigate through the data that is made available by the present invention.

It should be appreciated that the database module 16 utilizes suitable algorithms and/or database techniques to accept data for storage, store data in tables and present data in a preferred format. The technical details of such functionality will be apparent to those skilled in the art upon a reading and understanding of the present disclosure. In addition, the database module may also utilize suitable algorithms to perform necessary operations such as calculation of unreliability (e.g. excessive unexcused absences or exceptions) or calculation of factors regarding employee merit (e.g. consecutive days of attendance).

The tables 20 may take a variety of configurations; however, the tables preferably correspond to the categories of data referenced above. That is, tables are preferably maintained for the identification of employees, locations (or assignments) of employees, employee numbers (or clock numbers), hire dates for employees, available time off for employees, historical information on employee attendance, times of any “punch in” and times of any “punch out.”

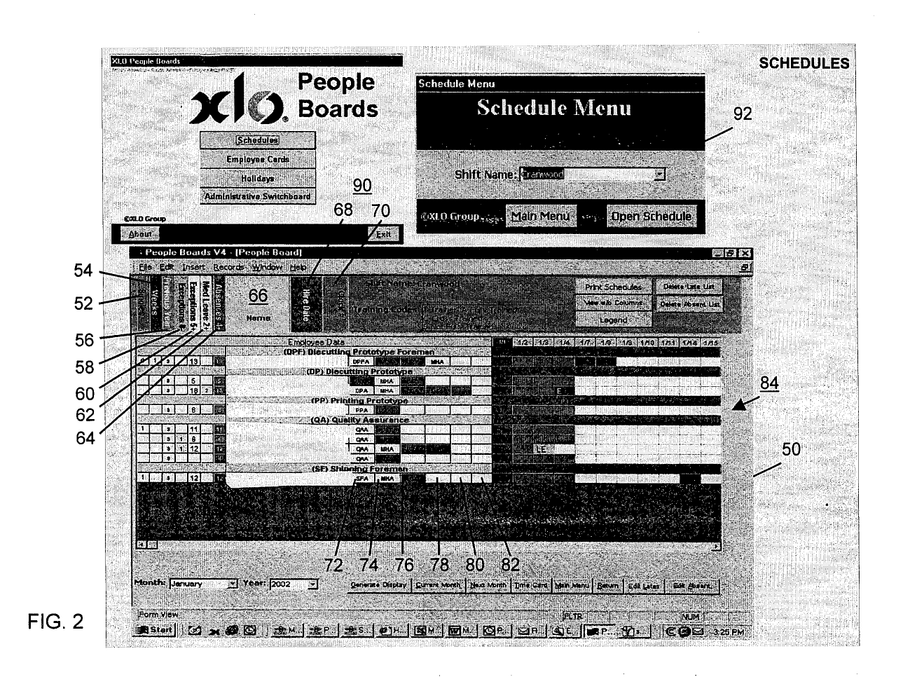

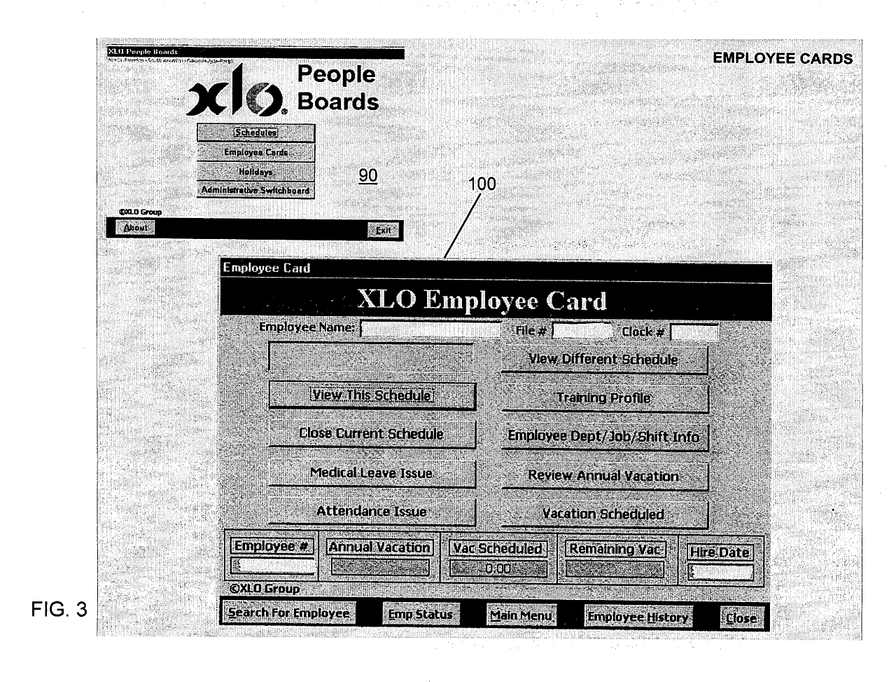

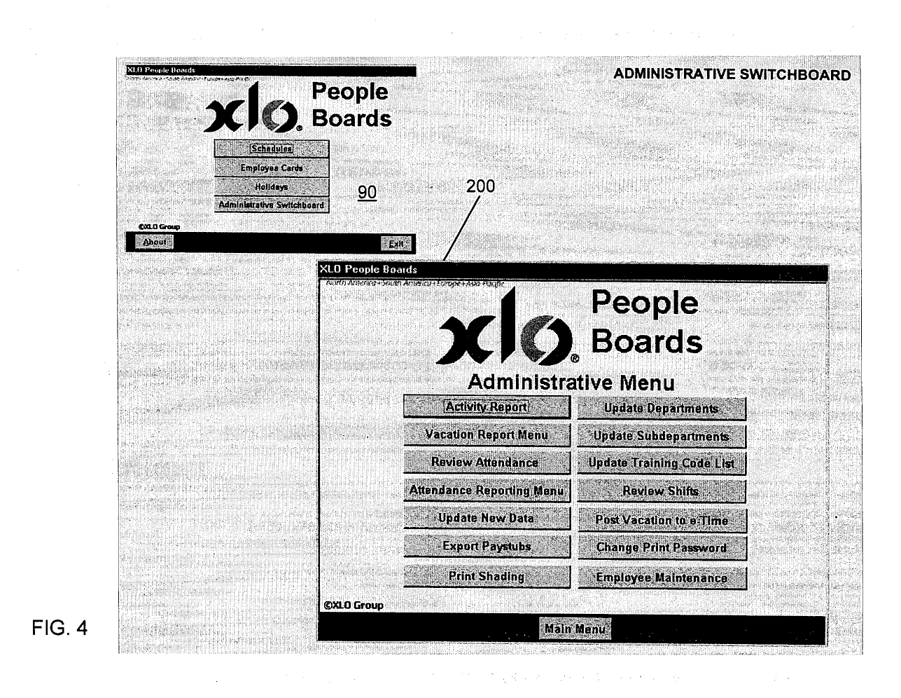

The templates or forms 22 are populated with data from the tables and, where appropriate such as in connection with FIG. 2, take the form of a spreadsheet that provides the user with an instant visual representation of an employee's daily attendance (including that for the present day), attendance history (which is an indicator of reliability), available paid time off, current vacation schedule, assignment status, training status, and the like. It is to be understood that the format, while taking a variety of acceptable configurations, is consistent with the principles of Visual Factory Management—which are well to those in the manufacturing industry as allowing for the reading and identifying of objects or areas with colors or shapes. As such, the templates or forms of the present invention provide data in a color-coded format. Data and functionality of the system may also be viewed in other convenient formats such as in connection with FIGS. 3 and 4.

Generally, the data utilized and/or displayed by the database module 16 is provided to the database module by the attendance module and/or the payroll module. However, certain data stored in tables (or data fields), is manually input to the database module and resides exclusively therein. Such data includes the training status of each of the employees registered on the system.

In its basic operation, the system 10 of the present invention utilizes data that is provided by the attendance module 12 and the payroll module 14, as well as data that is manually input to the database module 16, to provide an attendance monitoring solution for the manufacturing industry. For example, the attendance module outputs the name, department (or assignment), time of a “punch in” and time of any “punch out” for particular employees. This information may be provided to the payroll module; however, it may also be provided directly to the database module. Likewise, the payroll module outputs data that is utilized by the database module. The payroll data includes the identification of employees, locations (or assignments) of employees, employee numbers (or clock numbers), hire dates for employees, available time off for employees, and historical information on employee attendance. To suit a particular implementation, it is recognized that payroll data may also or alternatively be provided to the attendance module. It is further understood that, depending on the precise implementation, data may be exchanged between any of the components 12, 14 and 16. This will reduce the input of duplicative data and increase reliability. For example, employee records can be updated upon, for example, the hiring of a new employee by inputting and sharing suitable information. Moreover, different types of data, such as vacation data, can be maintained in a more efficient and reliable manner.

All of this data, as well as the data that is manually input to the database, is suitably stored in the tables 20. The information stored in the tables is then manipulated and/or simply input in a predetermined manner to the forms or templates 22 for visual display. As noted above, the information is preferably provided in color-coded format. Examples of such color-coding are described herein but such examples should not be construed as any limitation on the invention. Those of skill in the field will recognize other uses of color-coding to enhance the invention upon a reading and understanding of this invention.

Along these lines, reference is now made to FIGS. 2-4—which illustrate an implementation of a system according to embodiments of the present invention. As shown, a form or template 50 includes a variety of columns containing corresponding information.

In the configuration shown, singles column 52 includes information on the number of single days of vacation that is available to individual employees. Likewise, the weeks column 54 includes information on the number of weeks of vacation that is available to individual employees. A previous year column 56 illustrates, according to predetermined criteria that is preferably understood by the users, the employee's attendance performance of the previous year. Exceptions columns 58 and 60 indicate data relating to days in the current year that account for work days of less than eight (8) hour days for an employee due to tardiness, early departures from a shift, . . . etc. Medical leave column 62 indicates data on medical leaves taken by the employee for the current year. Attendance column 64 indicates data on a number of unexcused absences for the employee for the current year.

Of course, name column 66 indicates the names (not shown) of employees whose data is contained within the rows. The names may be color-coded to indicate an assignment of the employee to a department, for example. Columns 68 and 70 are provided to display the hire date and clock number (not shown), respectively, for the employees. Also provided are columns 72, 74, 76, 78, 80, and 82 to indicate the training status of employees. This data is color-coded by department and includes text as to a level of training. The plurality of columns of date blocks 84 is also provided such that each column corresponds to a day within the month being viewed. These columns provide color-coded information to allow for convenient visual inspection to determine if an employee “punched in,” was late, left early, . . . etc.

Along these lines, the employee's name will flash on the output 50 to identify the employee's absence. Such an absence is determined preferably at the beginning of a shift, upon return from a lunch break, or if the employee punches out with less than eight hours work. Preferably, after a predetermined amount of time (before which “lateness” may be indicated in color), the corresponding individual date block for that day will turn red for an absent employee. Employees who arrive late or leave early will have a corresponding date block in the color of, for example, orange. Likewise, employees on medical leave will be identified with a date block flashing in, for example, yellow. This color-coding feature will allow supervisors to be able to conveniently identify available staff on a particular day. As noted above, it will also allow for convenient reassignment, when appropriate. The training status also provides information that may be used in assignment or reassignment decisions.

Also illustrated in FIG. 2 is the main menu 90 and a schedule menu 92. Main menu 90 allows users to navigate to a schedules section of the database module, which comprises the schedule menu 92 and the form or template 50. Main menu 90 also allows for navigation to sections for employee or time cards (FIG. 3), holidays (not shown but allows for customization and input of a holiday schedule according to an organization's objectives), and an administrative switchboard (FIG. 4).

In further embodiments of the present invention, the above-referenced employee card of an employee is subject to display. An example of such a employee card 100 is shown in FIG. 3. As can be seen, several functions can be accomplished through manipulation of employee card 100. This will assist in clarifying or resolving issues that may arise regarding, for example, inadvertent punches. For example, display of the employee card will allow for an employee to verify whether a punch in or a punch out was missed so that it can be corrected for proper processing.

In addition to the functions noted thus far, the system preferably generates reports based on the data stored within the system. For example, reports on individual employee attendance, summary employee attendance, whether an employee is about to exceed a limit such as a vacation limit, transaction history (i.e. history of assignments for an employee) and exception reports are generated at the request of a user, through the manipulation of an administrative switchboard 200, for example, that may be provided to the system that is shown in FIG. 4. Such reports may also be generated on a regular, scheduled basis as desired. As can be seen, the switchboard 200 accommodates a variety of functions such as reporting, updating, exporting, reviewing, posting, editing . . . etc.

The system also preferably generates notices that are provided to particular employees. For example, suspension or termination notices are generated. Conversely, notices indicating exceptional attendance performance are generated.

Further, in its preferred format, the present form or table (e.g. template 50) is expandable into a larger calendar format to make it more convenient to identify trends in attendance of particular employees or of groups of employees. This will allow for convenient analysis and planning.

In further embodiments of the present invention, the system will print out employee I.D. cards. Such I.D. cards will include data extracted from the tables from the database module. For example, the I.D. cards will include the training level of an employee and color-coding to match all coding that is displayed as output of the database module.

In still further embodiments of the invention, the human resources personnel of a particular company will be provided with a warning when vacation time is being entered in excess of the available vacation for that particular employee.

The above-described invention is described in terms of an overall system and a specific implementation thereof. It is to be appreciated that the features of the present invention may be implemented in a variety of hardware and/or software configurations that will become apparent to those of skill in the art upon a reading and understanding of the present disclosure.

The above description merely provides a disclosure of particular embodiments of the invention and is not intended for the purposes of limiting the same thereto. As such, the invention is not limited to only the above-described embodiments. Rather, it is recognized that one skilled in the art could conceive alternative embodiments that fall within the scope of the invention.

What is claimed is:

1. An attendance monitoring system, including:
an attendance module for generating daily records of employees, the daily records identifying beginning times when the employees report to work for paid work periods and ending times for the paid work periods;
a payroll module for generating employee paychecks including compensation for employees during a particular period of time; and
a database module in communication with the attendance module and the payroll module for generating employee attendance information to aid in management of employee resources.

2. The attendance monitoring system set forth in claim 1, the database module including:
a plurality of data tables;
a first plurality of algorithms for accepting employee data, storing the employee data in the data tables, and presenting employee data in preferred employee report formats;
a plurality of templates accepting and using the employee data stored in the data tables and providing a user interface to manually enter employee data into the data tables; and
a second plurality of algorithms for calculating parameters associated with the employee data.

3. The attendance monitoring system set forth in claim 2, wherein users use the templates to view and navigate through the employee data.

4. The attendance monitoring system set forth in claim 2, wherein the parameters calculated by the second plurality of algorithms includes at least one of employee reliability and employee merit.

5. The attendance monitoring system set forth in claim 2, wherein the data tables include a data table for storage of at least one of identification of employees, assignment of employees, employee numbers, hiring dates for employees, available time off for employees, historical information on employees attendance, beginning times when employees report to work for paid work periods, and ending times for the paid work periods.

6. The attendance monitoring system set forth in claim 2, wherein at least one template is in the form of a spreadsheet.

7. The attendance monitoring system set forth in claim 2, wherein the plurality of templates provide at least one of an employee's daily attendance, an employee's attendance history, an employee's available paid time off, an employee's vacation schedule, an employee's assignment status, and an employee's training status.

8. The attendance monitoring system set forth in claim 7, wherein the format of the employee data presented in the plurality of templates is consistent with principles of visual factory management.

9. The attendance monitoring system set forth in claim 7, wherein the format of the employee data presented in the plurality of templates provides data in a color-coded format.

10. The attendance monitoring system set forth in claim 7, wherein the format of the employee data presented in the plurality of templates includes flashing names of absent employees.

11. The attendance monitoring system set forth in claim 2, wherein the employee data stored in the data tables is provided from at least one of the attendance module, the payroll module, and a database module user via one or more of the templates.

12. The attendance monitoring system set forth in claim 11, wherein employee data provided from the attendance module includes at least one of employee name, employee assignment, beginning time when an employee reports to work for paid work periods, and ending time for the paid work periods.

13. The attendance monitoring system set forth in claim 12, wherein employee data provided by the attendance module is also provided to the payroll module.

14. The attendance monitoring system set forth in claim 11, wherein employee data provided from the payroll module includes at least one of employee identification, employee assignment, employee numbers, employee hiring date, an employee's available time off, and historical information on employee attendance.

15. The attendance monitoring system set forth in claim 14, wherein employee data provided by the payroll module is also provided to the attendance module.

16. The attendance monitoring system set forth in claim 2, the plurality of templates including:
a main menu screen module;
a schedule menu screen module for selection of employee shifts;
a plurality of employee cards for selection of individual employees;
a plurality of employee data templates for displaying individual employee data and employee shift data;
a holiday schedule screen module for establishing a customized holiday schedule; and
an administrative switchboard screen module for selecting between various database module reporting, updating, exporting, reviewing, posting, and editing features.

17. The attendance monitoring system set forth in claim 16, wherein database module reporting features accessed through the administrative switchboard include at least one of individual employee attendance reports, summary employee attendance reports, reports indicating whether an employee is about to exceed a limit, employee transaction history reports, user-requested exception reports, employee suspension notice, employee termination notice, exceptional employee attendance performance notice, and employee identification cards.

18. The attendance monitoring system set forth in claim 17, wherein the reports are generated on a regularly scheduled basis.

19. The attendance monitoring system set forth in claim 2, wherein appropriate personnel are provided with a warning when vacation time is being entered in excess of available vacation time for a particular employee.

20. A method of monitoring employee attendance to aid in management of employee resources, the method including the following steps:
a) receiving and storing identification and assignment information for employees from a user interface associated with at least one of an attendance module, a payroll module, and a database module;
b) receiving and storing beginning times when employees report to work for paid work periods and ending times for the paid work periods from an electronic terminal;
c) receiving and storing employee training status from the user interface associated with at least one of an attendance module, a payroll module, and a database module; and
d) reviewing current employee information to identify available employee resources at any given time to aid in re-assignment of employees.

21. The method as set forth in claim 20, further including:
e) determining and storing employee attendance information from current employee information; and
f) reviewing employee attendance information to determine at least one of employee reliability and employee merit.

22. The method as set forth in claim 21, further including before step d):
g) receiving and storing employee hiring dates for employees from the user interface associated with at least one of an attendance module, a payroll module, and a database module; and
h) receiving and storing available time off for employees from the user interface associated with at least one of an attendance module, a payroll module, and a database module.

23. The method as set forth in claim 22, further including:
i) generating reports from the employee information and the employee attendance information including at least one of individual employee attendance reports, summary employee attendance reports, reports indicating whether an employee is about to exceed a limit, employee transaction history reports, user-requested exception reports, employee suspension notice, employee termination notice, exceptional employee attendance performance notice, and employee identification cards.

24. An attendance monitoring system, including:
a means for creating and maintaining employee identification and personal records;
a means for generating daily records of employees, the daily records identifying beginning times when the employees report to work for paid work periods and ending times for the paid work periods; and
a means for generating employee attendance information to aid in management of employee resources from the employee identification and personal records and the daily time records.
